(19) United States
(12) Patent Application Publication
(10) Pub. No.: US 2006/0097911 A1
(43) Pub. Date: May 11, 2006

(54) Wire positioning and mechanical attachment for a radio-frequency indentification device

(75) Inventors: Christian Bussiere, Quebec (CA); Nicolas Schieli, Quebec (CA)

Correspondence Address: VENABLE LLP, P.O. BOX 34385, WASHINGTON, DC, 20045-9998, US

(73) Assignee: Quelis ID Systems Inc., Mirabel (CA)

(21) Appl. No.: 10/520,121

(22) PCT Filed: Jul. 2, 2003
(86) PCT No.: PCT/CA03/01003

§ 371 Date: Aug. 31, 2005

(30) Foreign Application Priority Data
Jul. 3, 2002 (US) 60393317

(51) Int. Cl. G01S 13/00

(52) U.S. Cl. 342/175

(57) ABSTRACT

An antenna terminal positioning structure for a radio-frequency identification device having terminal pads mounted to one of its surface is obtained providing a wall assembly mounted to the device surface, the wall assembly having at least one wall surface extending from the device surface so as to be aligned with a target area on the electrical pad. The target is sufficiently large to receive the antenna terminal. An appropriate positioning of the antenna terminal on the pad is obtained by abutting the antenna terminal against the at least one wall surface. A mechanical attachment is activated between the antenna terminal and the positioning structure using a well-known process such as thermo-compression, ultra-violet (UV) or Laser soldering, mono or bi-components gluing etc., depending of the material of the positioning structure. The present positioning structure and attachment process are also applicable in other micro-electronic fields such as micro-sensors and micro-electronic machines (MEMs).

### FIELD OF THE INVENTION

The present invention relates to radio-frequency identification devices (RFID). More specifically, the present invention is concerned with a wire positioning structure and mechanical attachment process thereof.

### BACKGROUND OF THE INVENTION

The manufacturing of miniaturized radio-frequency identification devices (RFID) is generally divided in two sequential steps: 1) the winding of an ultra-fine magnet wire (typically 50 μm to 20 μm diameter or less) to provide an air-coil—the antenna—, and 2) the subsequent connection of the one or two terminals of the coil to the pads of a microchip.

One of the main difficulties in a mass production process lies in the positioning and in the attachment of the coil wire ends on the standard microchip pads, which typically measure 100×100 μm or less.

Traditionally, to avoid this complex operation, the electrical standard pads are enlarged or additional enlarged pads, that measure typically 200×600 μm, are electrically connected to the small standard pads. Generally, this large pad insertion requires a microchip redesign and increases the size of such microchip.

Improved wire positioning and mechanical attachment process for RFID are thus desirable.

### SUMMARY OF THE INVENTION

The purpose of the invention is to provide means for positioning the coil terminals above the small standard pads of an RFID microchip for electrical connection, and for providing a strong and reliable mechanical attachment between the coil and the microchip.

More specifically, according to a first aspect of the present invention, there is provided an antenna terminal positioning structure for a radio-frequency identification device having an electrical pad mounted on an electronic integrated circuit (IC), the structure comprising:

a wall assembly mounted on the electronic IC and having at least one wall surface extending from the IC so as to be aligned with a target area on the electrical pad; the target area being sufficiently large to receive an antenna terminal of a radio-frequency identification device; whereby abutting the antenna terminal against the at least one wall surface allows positioning the antenna terminal on the electrical pad.

According to a second aspect of the present invention, there is provided a method for positioning an antenna terminal of a radio-frequency identification device on an electrical pad of an electronic circuit, the method comprising:

providing on the electronic circuit a wall assembly that has at least one wall surface extending from the electronic circuit so as to be aligned with a target area on the electrical pad; the target area being sufficiently large to receive an antenna terminal from the radio-frequency identification device; and

contacting the antenna terminal with the at least one wall surface, while ensuring that a portion of said antenna terminal is at the height of the electrical pad.

According to a first embodiment of the present invention, the positioning and the mechanical attachment are obtained by adding a thin layer (about 15 μm to 250 μm) of attachment material above the microchip protection layer. This attachment layer has a geometry and a placement that allow a precise, stable and fast coil terminals positioning. According to the first embodiment, the attachment material is so chosen so that the attachment layer does not play any electrical part. The electrical connection is made with the small standard electrical pads while the positioning and the mechanical attachment is made with the geometry of the attachment layer.

The electrical connection and the mechanical attachment can be made during the same operation or during two distinct operations depending of the microchip and antenna architecture, the electrical connection process and of the attachment process.

According to a second embodiment, the wire positioning can be improved by adding a specific positioning structure, made of electrical conductive material, on the small standard electrical pads of such microchip.

Moreover, the wire positioning structure can be made by a specific design of the electrical conductive material used for the enlarged electrical pads added on some microchips.

Also, the wire positioning can be improved by splitting the small standard electrical pads in two dual miniature electrical pads and adding a positioning structure, made of electrical conductive material, on each part of the dual miniature electrical pads of such microchip. The antenna wire positioning is obtained by the spacing between both parts of the dual miniature electrical pads.

In addition, the positioning structure can be obtained by making a specific topology of the microchip protection layer during the microchip manufacturing process itself, which yields an embedded positioning structure.

Such a positioning structure can be drawn to be used as a optical marks for real time image processing for microchip alignment and positioning in the RFID manufacturing process.

A positioning structure and attachment process according to the present invention is applicable for all RFID microchips whatever are the frequency range and the antenna geometry.

Such a positioning structure and attachment process according to the present invention is also applicable in other micro-electronic fields like micro-sensors or micro-electronic machines (MEMs).

A wire positioning structures according to the present invention provides a significant tool to improve the image processing cycle, helping to reduce the microchip handling and positioning process and contributing to reduce a product manufacturing cycle time.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a top plan view of a RFID microchip including two terminal positioning structures for a radio-frequency identification device according to a first illustrative embodiment of the present invention;

FIG. 2 is a cross section taken along line 2-2 on FIG. 1;

FIG. 3 is a cross section taken along line 3-3 on FIG. 1;

FIG. 4 is a top plan view of a RFID microchip including terminal positioning structures for a radio-frequency identification device according to a second and a third illustrative embodiments of the present invention;

FIG. 5 is a top plan view of a RFID microchip including two terminal positioning structures for a radio-frequency identification device according to a fourth illustrative embodiment of the present invention;

FIG. 6 is a cross section taken along line 6-6 on FIG. 5;

FIG. 7 is a top plan view of a RFID microchip including a terminal positioning structure for a radio-frequency identification device according to a fifth illustrative embodiment of the present invention;

FIGS. 8A and 8B are cross sections of a RFID microchip including terminal positioning structures for a radio-frequency identification device respectively according to a sixth and a seventh illustrative embodiments of the present invention;

FIG. 9 is a top plan view of a RFID microchip including two terminal positioning structures for a radio-frequency identification device according to an eight illustrative embodiment of the present invention;

FIG. 10 is a top plan view of a RFID microchip including two terminal positioning structures for a radio-frequency identification device according to a ninth illustrative embodiment of the present invention;

FIG. 11 is a top plan view of a RFID microchip including two terminal positioning structures for a radio-frequency identification device according to a tenth illustrative embodiment of the present invention;

FIG. 12 is a top plan view of a RFID microchip including two terminal positioning structures for a radio-frequency identification device according to an eleventh illustrative embodiment of the present invention;

FIG. 13 is a top plan view of a RFID microchip including two terminal positioning structures for a radio-frequency identification device according to a twelfth illustrative embodiment of the present invention;

FIG. 14 is a cross section taken along line 14-14 on FIG. 13;

FIG. 15 is a cross section, similar to FIG. 14, of a RFID microchip including two terminal positioning structures for a radio-frequency identification device according to a thirtieth illustrative embodiment of the present invention;

FIG. 16 is a top plan view of a RFID microchip including two terminal positioning structures for a radio-frequency identification device according to a fortieth illustrative embodiment of the present invention;

FIG. 17 is a top plan view of a RFID microchip including two terminal positioning structures for a radio-frequency identification device according to a fiftieth illustrative embodiment of the present invention;

FIG. 18 is a cross section taken along line 18-18 on FIG. 17;

FIG. 19 is a cross section taken along line 19-19 on FIG. 17;

FIG. 20 is a top plan view of a RFID microchip including two terminal positioning structures for a radio-frequency identification device according to a sixtieth illustrative embodiment of the present invention; and

FIG. 21 is a cross section taken along line 21-21 on FIG. 20.

### DETAILED DESCRIPTION OF THE INVENTION

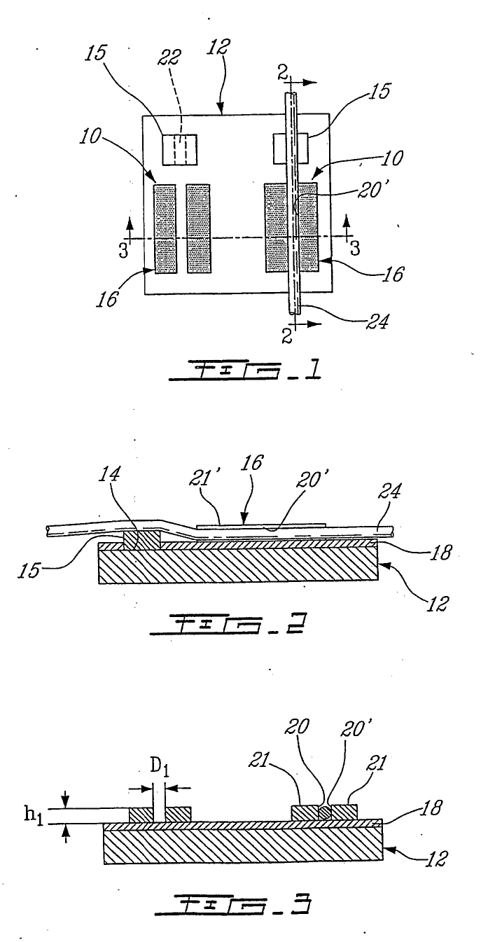

A terminal positioning structure 10 for a radio-frequency identification device (RFID) according to a first illustrative embodiment of the present invention will now be described with reference to FIGS. 1 to 3.

FIGS. 1-3 illustrate an electronic integrated circuit (IC) in the form of a RFID microchip 12 including two conventional electrical pads 14 mounted thereon Most conventional pads have a dimension of 100 μm×100 μm or less. However, for some ICs, pad dimensions are 120×120 um).

Each electrical pads 14 are covered by a bump 15 made of an electrically conductive material and being sufficiently thick so as protrude from a protective layer 18 of the microchip 12.

Two identical terminal positioning structures 10 are illustrated in FIGS. 1-3. Each of the structures 10 comprises a wall assembly 16 mounted to the protection layer 18 of the microchip 12. The wall assembly 16 includes two opposite parallel surfaces 20 and 20′ each extending perpendicularly from the microchip 12, and therefore from the protective layer 18, so as to be generally aligned with a target area 22 on the bump electrical pad 14.

The target area 22 represents a predetermined portion of the bump 15 (or of the pad 14) that should contact with the terminal 24 when the terminal 24 abuts against at least one of the two perpendicular wall surface 20 and 20′.

The structure 10 is so configured and so positioned relative to the pad 14 that the surfaces 20 and 20′ are aligned with the target area 22.

Of course, the target area 22 is only schematically represented on FIG. 1, and does not represent any component distinct from the pad 14. The target area 22 is configured and sized to receive a portion of the antenna terminal 24 sufficiently large to provide good electrical contact with the pad 14 via the bump 15 mounted thereon.

The terminal positioning structure 10 is made from an additional layer of attachment material, such as thin film polymide, deposited onto the microchip protection layer 18. Therefore, the structure 10 allows for both positioning and mechanical attachment of the antenna terminal 24.

The altitude of the antenna terminal 24 above the microchip protection layer 18 is determined by the design rules, including the spacing D₁, and by other parameters of the manufacturing process used such as the material thickness h₁, etching profile etc.

In operation, the antenna terminal 24 is moved from a first position away from the surface of the microchip 12 that includes the pad 14 to a second position where it contacts at least the surfaces 21-21′ of the wall assembly 16 that are parallel to the microchip surface, while ensuring that a portion of the antenna terminal 24 is at the height of the electrical pad 14.

The wall assembly 16 allows to provide an antenna terminal receiving area, defined by the two surfaces 21-21′ and their inter-space, which is bigger than the pad 14. As it is commonly known, a user or automatic equipment contacting the wall assembly 16 with an antenna terminal 24 has only to swipe the terminal 24 on the surfaces 21-21′ of the wall assembly 16 until the antenna terminal 24 engages the groove formed by the wall assembly 16. The sliding movement of the terminal 24 is stopped when the antenna terminal 24 abuts against one of the two wall surfaces 20 and 20′.

When a portion of the antenna terminal 24 contacts the pad 14, a mechanical attachment is activated between the antenna terminal 24 and the positioning structure using a well-known process such as thermo-compression, ultra-violet (UV) or laser soldering, mono or bi-components gluing etc., depending of the material of the positioning structure 16. In the particular case illustrated in FIGS. 1-3, UV activation or a laser soldering process can be used since the positioning structure material is made of polymide material or screen-printed UV glue.

This optional attachment process of the wire 24 on the positioning structure 16 can be executed before, after or at the same time of the electrical connection operation of the wire 24 on the small electrical pad 14 via the bump 15.

The thickness of the positioning/attachment material may vary from 15 μm to 250 μm depending on the nature of material and of the desired configuration of the positioning structure.

The bump 15 can be made of any electrically conductive material such as a noble material, conductive alloy, conductive paste or conductive film etc.

Even though the electrical pad 14 is illustrated as being covered by a bump 15, it can also be bared.

The configuration and size of the positioning structure may vary as will be described hereinbelow.

FIG. 4 illustrates a RFID microchip 12 comprising two electrical pads 31 and 33 for connecting antenna terminals 24, and two antenna terminal positioning structures 26-28 according respectively to a second and third illustrative embodiments of the present invention.

Since the structures 26 and 28 are similar to the positioning structure 10, and for concision purposes, only the differences between each of the structures 26 and 28 and the structure 10 will be described.

The positioning structures 26-28 comprise respective wall assembly 30-32 mounted to the microchip 12.

The wall assembly 30 includes two facing concave surfaces 34 and 34′ extending generally perpendicularly from the microchip 12 surface so as to be generally aligned with a target area (not shown) on the electrical pad 31.

The wall assembly 32 includes two facing skew surfaces 36 and 36′ extending generally perpendicularly from the microchip 12 surface so as to defined a tapered groove generally aligned with a target area 35 on the electrical pad 33.

Each of the two resulted grooves is configured to have multiple cross-sections, which contribute to ease the positioning of a wire 24 therein.

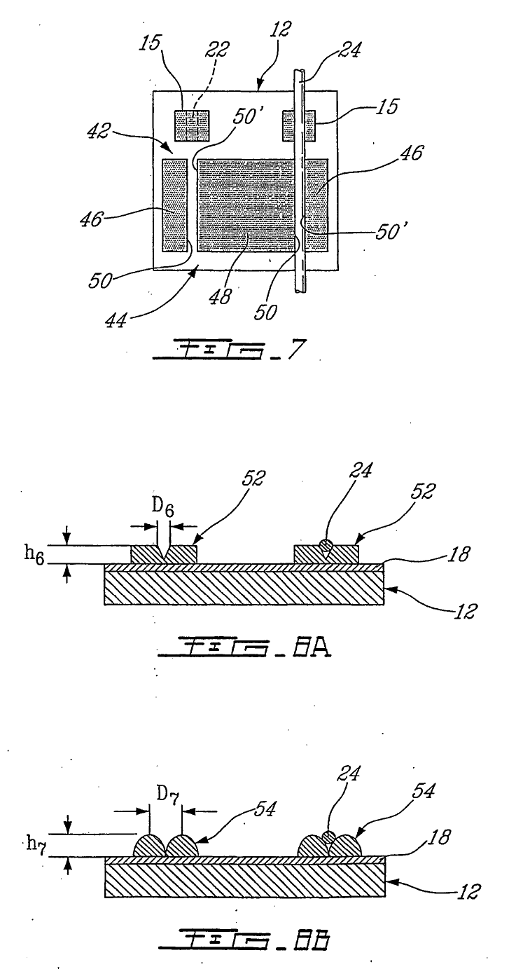

Turning now to FIGS. 5 and 6, an antenna terminal positioning structure 38 for a RFID device according to a fourth illustrative embodiment of the present invention will now be described.

Two identical positioning structures 38 are illustrated in FIGS. 5 and 6. Each of the two positioning structures 38 includes two spaced hemispheres 40, each defining a surface that is tangentially aligned with a target area 22 on a facing bump 15 covering the electrical pad 14.

The positioning structures 16, 30, 32, and 40 can be made of electrical conductive or non-conductive material, since they provide no electrical function. It is to be noted that the antenna terminals do not required to be stripped off to obtain a strong and reliable attachment to these positioning structures.

FIG. 7 illustrates an antenna terminal positioning structure 42 for a RFID device according to a fifth illustrative embodiment of the present invention.

The structure 42 comprises a wall assembly 44 mounted to the protection layer 18 of the microchip 12. The wall assembly 16 includes two external rectangular-shaped portions 46 and an internal generally square-shaped portion 48 therebetween. The three portions 46-48 are positioned parallel and are consecutively distanced so as to yields two interspaces, each defining two opposite parallel surfaces 50-50′ that are generally aligned with a target area 22.

Since the internal portion 48 is to be contacted with two different antenna terminals 24 (only one shown), for a reliable operation, it is made from a electrical non-conductive material such as thin film polymide or UV glue etc.

The wall assemblies 16, 30, 32, 40, and 42 define grooves that are adapted to receive an antenna terminal 24 that is vertically set (following the Z-axis entering the page) onto the microchip 12.

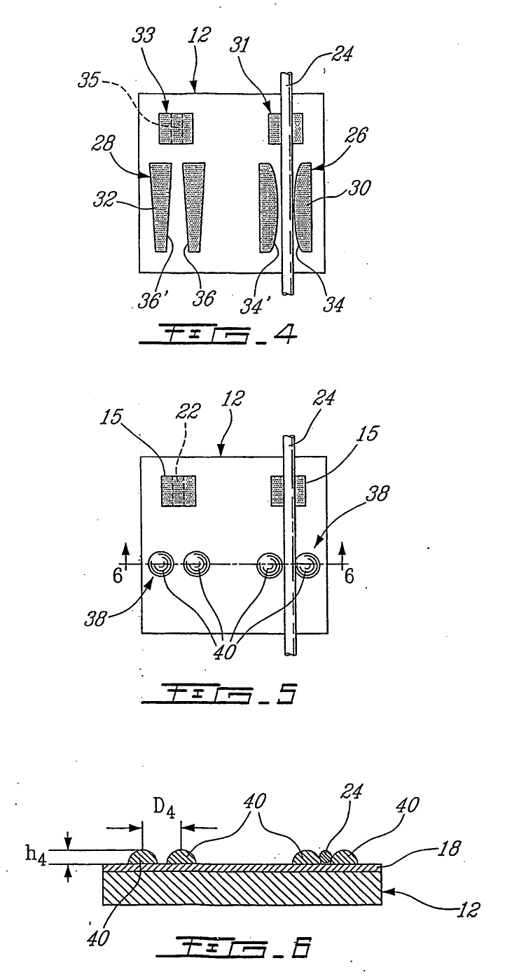

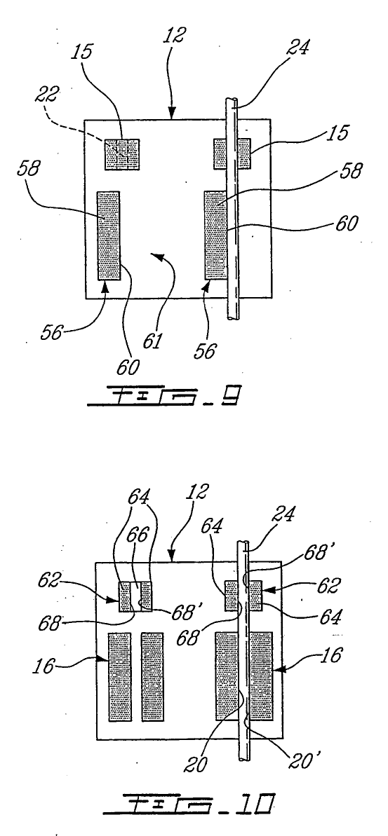

Depending on the material chosen for the positioning structure, on the manufacturing process and on the interspaces between the two opposite surfaces that are aligned with the target area 22 of the electrical pad 14, the antenna terminals 24 can be led on the microchip protection layer 18 as shown in FIGS. 3 and 6, or led directly on the positioning structure 52 or 54 as shown in FIGS. 8A and 8B illustrating antenna positioning structures respectively according to a sixth and a seventh illustrative embodiments of the present invention.

The sixth and seventh illustrative embodiments illustrated in FIGS. 8A and 8B are respectively similar to the first and fourth embodiments with the differences as follows. These two embodiments allows to control the altitude of the antenna terminal above the microchip surface.

The sixth embodiment results from the increase of the material thickness of the first embodiment from h₁ to h₆.

The seventh embodiment results from the increase of the material thickness of the fourth embodiment from h₄ to h₇ and from the diminution of the interspacing of the two opposite surfaces from D₄ to D₇.

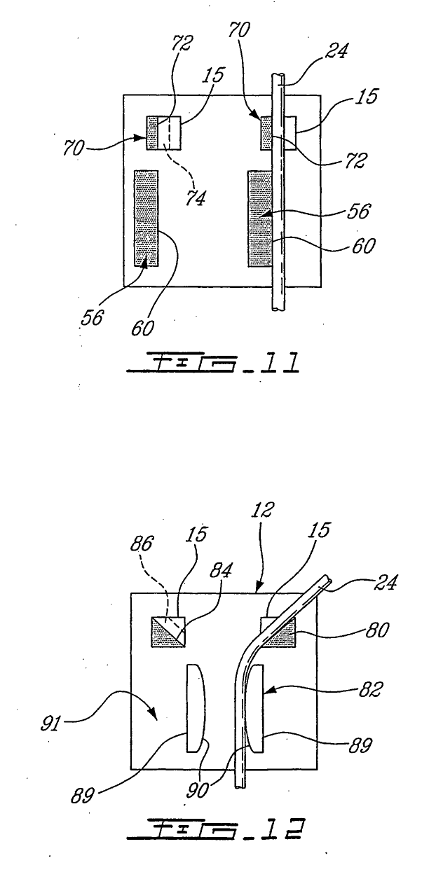

An antenna terminal positioning structure 56 for a RFID device according to an eight embodiment of the present invention will now be described with reference to FIG. 9.

Two identical positioning structures 56 are illustrated in FIG. 9. Each positioning structure 56 comprises a wall assembly in the form of a rectangular body 58 extending perpendicularly from the microchip surface 61. The rectangular body 58 is configured and positioned on the surface 61 of the microchip so as to have one of its surface 60 aligned with a target area 22 over the pad 14.

The rectangular body 58 constitutes half the wall assembly 16 illustrated in FIG. 1.

In operation, the antenna terminal 24 is moved from a first position away from the microchip 12 to a second position where it contacts the microchip surface 61 at a location between the border of the microchip surface 61 and the rectangular body 58. Then, the antenna terminal 24 is swiped on (or near) the microchip surface 61 until the antenna abuts the surface 60.

This ‘half’ positioning structure 56 is well adapted to set the antenna terminals 24 horizontally (following the X-axis in the plane of the page) onto the microchip 12.

Even though both positioning structures 56 are illustrated in FIG. 9 on the left side of the bump 15 and therefore of the pad, they can be positioned on the right side thereof the bump 15, or one on the left and the other on the right side of the respective bump 15 and pad.

Of course, to be more reliable, the body 58 is made sufficiently thick (typically 1.25 to 2 times the wire diameter) compared to the wire 24 diameter and its edges are made sufficiently sharp.

Turning now to FIG. 10 a RFID microchip including two identical terminal positioning structures for a radio-frequency identification device according to a ninth illustrative embodiment of the present invention will be described.

The positioning structure according to the ninth illustrative embodiment of the present invention comprises a first wall assembly 16 identical to those illustrated in FIGS. 1-3, and a second wall assembly 62 made of an electrical conductive material and mounted to the small electrical pad 14.

The second wall assembly 62 includes a wall 64 on both side of a target area 66. Each wall 64 defines facing wall surfaces 68 and 68′ that are aligned with the target area 66.

Due to the small size of the contacting surface of the pad 14, this embodiment can only be used for very fine wire diameter (25% or less than pad 14 size).

FIG. 11 illustrates an antenna terminal positioning structure for a RFID device according to a tenth embodiment of the present invention.

The positioning structure comprises a first wall assembly 56 similar to those illustrated in FIG. 9, and a second wall assembly in the form of a wall 70 made of an electrical conductive material and mounting to the electrical pad 14. The wall 70 includes a wall surface 72 adjacent the target area 74 and on the same side as the wall assembly 56 relative to the target area 74. The wall surface 72 extends perpendicularly from the pad 14 so as to be aligned with the target area 66.

The operation of the positioning structure according to the tenth embodiment of the present invention is identical to the operation of the eight embodiment illustrated in FIG. 9.

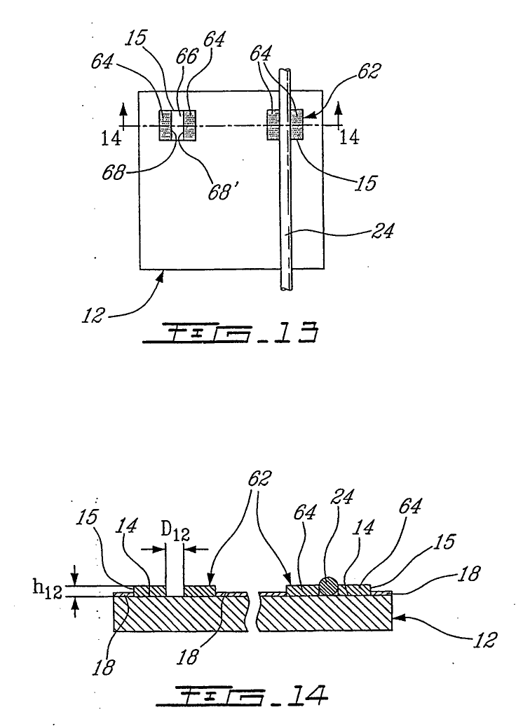

Turning now to FIG. 12, two symmetrical antenna terminal positioning structures for a RFID device according to an eleventh illustrative embodiment of the present invention will be described.

According to this eleventh embodiment, each positioning structure comprises a first wall assembly in the form of an triangular-shaped wall 80 made of an electrical conductive material and mounted to the electrical pad so as to extend thereof, and a second wall assembly, in the form of a semi-convex wall 82 extending from the microchip 12 surface 91 and being positioned generally perpendicularly from a surface of the first wall assembly 80 formed by one of the two even side of the triangle shaped wall 80. A portion of the microchip 12 adjacent the uneven side surface 84 of the first wall assembly 80 defines a target area 86 for the antenna terminal 24.

More specifically, the semi-convex wall 82 is in the form of an elongated generally rectangular-shaped body including a slightly convex surface 90 opposite a straight surface 89.

In operation, the antenna terminal 24 is moved from a first position away from the microchip 12 to a second position where it contacts the surface 91 of the microchip 12 between the two convex surfaces 90. Then, the antenna terminal 24 is swiped on (or near) microchip surface until the antenna abuts the slightly surface convex surface 90. Then, while the portion of the antenna 24 abutting against the surface 90 is maintained in place, the free portion of the antenna 24 extending in the direction of the first wall assembly 80 is swiped in the direction of the first wall assembly 80 until the antenna terminal 24 abuts the first wall assembly 80.

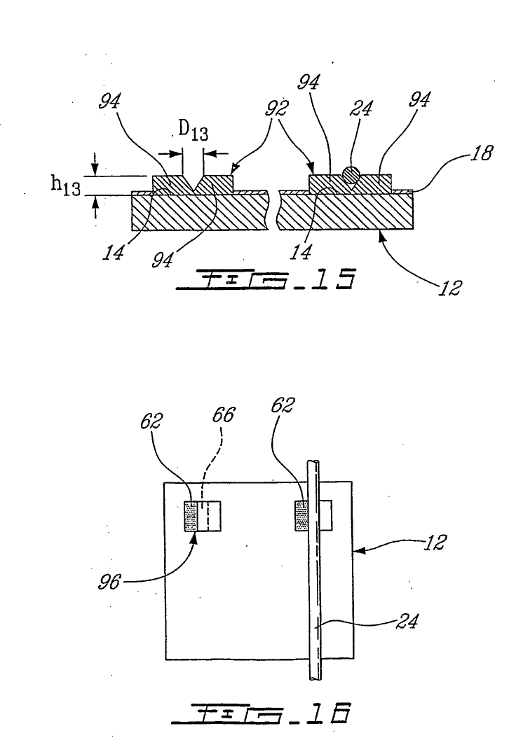

FIGS. 13 and 14 illustrate a RFID microchip 12 including two terminal positioning structures for a radio-frequency identification device according to a twelfth illustrative embodiment of the present invention.

Each such positioning structure is identical to the small wall assembly 62 illustrated in FIG. 10.

The use of the small wall assembly 62 as a positioning structure, without any positioning structure on the microchip protection layer, is suitable, for example, for products which do not require strong mechanical performances and when it is used with a very fine antenna wire (typically 25 μm or less).

These small structures 62 are made of an electrically conductive material since they are used for the electrical connection between the microchip 12 and the antenna 24

Increasing the material thickness of the positioning structure 62 from h₁₂ to h₁₃ and modifying the properties of the photolithography process used to create the microchip 12 results in the positioning structure 92 illustrated in FIG. 15.

Due to the small size of the pad 14, the manufacturing process (typically etching) to obtain sharp edge 62 can be very complex. The structure 92 provides a means to have a acceptable positioning structure. The other advantage of this ‘V’ profile is to keep some conductive material between the pad 14 and the terminal 24, and so to have a better conductive alloy after connection process.

Typically, in photolithography process, assuming the etching process is perfectly under control, a sharp edge is obtained (see FIG. 14) when the ratio spacing/thickness (D/h) is greater than the minimum specified design rules.

In FIG. 14, this ratio is greater than the minimum design rules and we obtain sharp edges and a full etching of the positioning structures 62.

In FIG. 15, the positioning material thickness (h) is increased and/or the spacing (D) between the two internal edges is reduced. Then the ratio D₁₃/h₁₃ is much lower than the minimum design rules and the typical etching process do not allow having sharp edges. One can use this design rules violation to create a specific positioning structure in ‘V’ on the top of positioning material 92.

This method is also applicable to obtain a specific topology for the additional positioning structures 52 deposited on the microchip protection layer 18 as shown in FIG. 6.

FIG. 16 illustrates a positioning structure 96 similar to the positioning structure of FIG. 13 but including only one small wall assembly 62 instead of two.

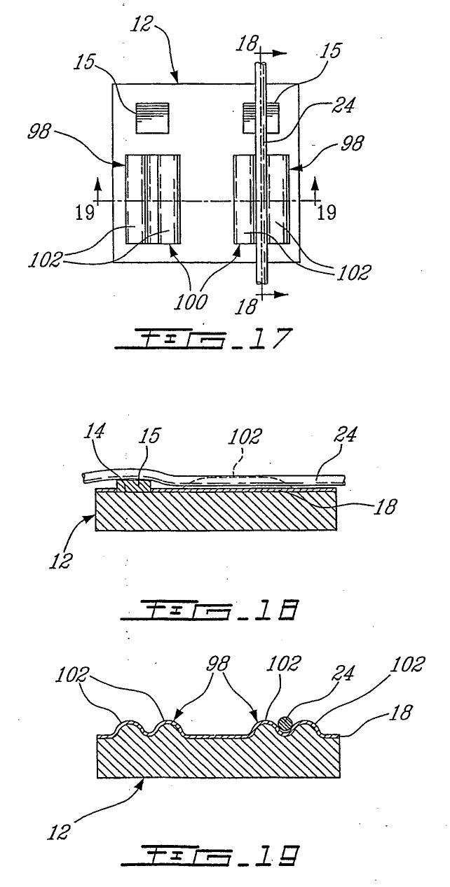

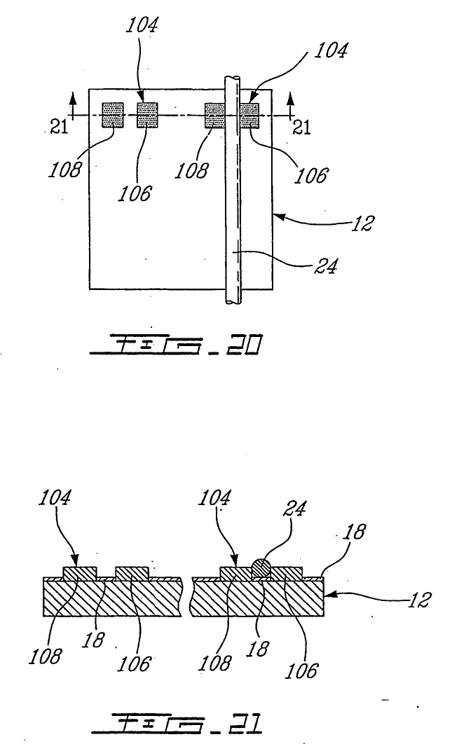

Turning now to FIGS. 17-19, a terminal positioning structure 98 for a radio-frequency identification device according to a fiftieth illustrative embodiment of the present invention will now be described.

FIGS. 17-19 illustrate an electronic circuit in the form of a RFID microchip 12 including two conventional electrical pads 14 covered by a bump 15.

Two identical terminal positioning structures 98 are illustrated in FIGS. 17-19. In this case, the positioning structures 98 are obtained by a specific topology of the microchip protection layer 18. This specific topology is the result of a specific design (and specific etching) of the embedded layers inside the microchip 12. The protection layer 18 covers the embedded layers and gives a smooth relief to the microchip surface, yielding two wall assemblies 100, each including two rounded rectangular wall 102.

The main advantage of this technique is the fact that the positioning structure 98 is made during the chip manufacturing process and then does not require any additional operation.

However, as the protection layer 18 is generally very strong (glassivation), a structure such as the positioning structure 98 allows only the wire positioning and not the mechanical attachment. This mechanical attachment is performed by adding a gluing material when the wire 24 is positioned.

FIGS. 20 and 21 illustrate two identical positioning structures 104. Each structure 104 is composed of two miniature pads 106 and 108. These two miniatures pads 106 and 108 are internally electrically connected. Miniatures pads 106 and 108 are placed by design to create spacing between them and are covered by a electrical conductive material in order to form a positioning structure for the wire terminal 24 as better shown on FIG. 21.

Each miniature pads 106 and 108 of the dual pads 104 has a reduced size (typically 60×100 μm or less) to avoid increasing the microchip overall size.

A wire or antenna terminal positioning and attachment structure according to the present invention can be placed on the microchip at the wafer level, or at the microchip level before or during the antenna positioning Depending of the positioning structure material and the manufacturing throughput required, the positioning structures can be placed on the microchip by different processes such as photolithography, electroplating, screen printing etc.

Of course, wire positioning structures according to the present invention are applicable for microchip having one, two or several small antenna pads.

Even though wire positioning structures according to the present invention have been illustrated in the context of RFID microchips, it can be used in other application where a small wire has to be contacted with a small electrical pad such as in micro-sensors or micro-electronic machines (MEMs). More generally, the present invention can be used to position wires on pads provided on a surface of electronic circuit having various form and configuration.

Although the present invention has been described hereinabove by way of preferred embodiments thereof, it can be modified without departing from the spirit and nature of the subject invention, as defined in the appended claims.

1. An antenna terminal positioning structure for a radio-frequency identification device having an electrical pad mounted on an electronic integrated circuit (IC), the structure comprising:
a wall assembly mounted on said electronic IC and having at least one wall surface extending from the IC so as to be aligned with a target area on the electrical pad; said target area being sufficiently large to receive an antenna terminal of a radio-frequency identification device;
whereby abutting said antenna terminal against said at least one wall surface allows positioning the antenna terminal on the electrical pad.

2. A positioning structure as recited in claim 1, wherein the electrical pad is composed of first and second miniature pads internally electrically connected together, and so positioned relative to each other as to yield an inter-spacing between them; said target area being positioned within said inter-spacing; said wall assembly including a first wall, defining a first wall surface, mounted on said first miniature pad adjacent said target area on a first side thereof so that said first wall surface is aligned with the target area.

3. A positioning structure as recited in claim 2, wherein said wall assembly further includes a second wall, defining a second wall surface, mounted adjacent said target area on said second miniature pad opposite said first side of the target area so as to be aligned with said target area.

4. A positioning structure as recited in claim 3, wherein said wall assembly further includes a second wall mounted on a protective layer of said electronic circuit surface on the same side as said first side relatively to the target area; said second wall being so configured and sized as to define a second wall surface aligned with said target area.

5. A positioning structure as recited in claim 1, said wall assembly includes a rectangular body extending from the electronic circuit surface.

6. A positioning structure as recited in claim 1, said at least one wall surface includes two opposite surfaces defining a groove generally aligned with said pad.

7. A positioning structure as recited in claim 6, wherein said two opposite surfaces are two facing concave surfaces.

8. A positioning structure as recited in claim 6, wherein said two opposite surfaces are two facing skew surfaces, defining a tapered groove generally aligned with said target area on the electrical pad.

9. A positioning structure as recited in claim 6, wherein each of said two opposite wall surfaces extends generally perpendicularly from the electronic circuit surface.

10. A positioning structure as recited in claim 1, wherein said wall assembly includes two spaced hemispheres, each defining a surface that is tangentially aligned with said target area.

11. A positioning structure as recited in claim 1, wherein the radio-frequency identification device have two electrical pads; said wall assembly includes two external rectangular-shaped portions and an internal generally square-shaped portion made of an electrically non-conductive material; said two external rectangular-shaped portions and said internal generally square-shaped portion being generally parallel and being consecutively distanced so as to yields two interspaces that are generally aligned with a respective target area.

12. A positioning structure as recited in claim 1, wherein said wall assembly is made from a material deposited on the electronic IC.

13. A positioning structure as recited in claim 12, wherein said material deposited on the electronic IC is selected from the group consisting of polymide and ultra-violet glue.

14. A positioning structure as recited in claim 12, wherein said material is electrically conductive.

15. A positioning structure as recited in claim 12, wherein said material is electrically non-conductive.

16. A positioning structure as recited in claim 1, wherein said wall assembly includes a first wall, defining a first wall surface, mounted on the electrical pad adjacent the target area on a first side thereof so that said first wall surface is aligned with the target area.

17. A positioning structure as recited in claim 16, wherein said wall assembly further includes a second wall, defining a second wall surface, mounted adjacent said target area on a second side opposite said first side of the target area so as to be aligned with said target area.

18. A positioning structure as recited in claim 16, wherein said wall assembly further includes a second wall mounted on a protective layer of said electronic circuit surface on the same side as said first side relatively to the electrical pad; said second wall being so configured and sized as to define a second wall surface aligned with said target area.

19. A positioning structure as recited in claim 18, wherein said first wall is triangular prism-shaped and said second wall surface is convex and is substantially tangentially aligned with the target area.

20. A positioning structure as recited in claim 1, wherein said geometry structure is mounted on a protective layer on said electronic circuit surface.

21. A positioning structure as recited in claim 1, wherein said wall assembly includes two facing concave surfaces extending generally perpendicularly from the electronic IC so as to be generally aligned with said target area.

22. A positioning structure as recited in claim 1, wherein said electronic IC is selected from the group consisting of a radio-frequency identification device microchip, a micro sensor microchip or and micro electronic machine (MEM).

23. A method for positioning an antenna terminal of a radio-frequency identification device on an electrical pad of an electronic circuit, the method comprising:
providing on the electronic circuit a wall assembly that has at least one wall surface extending from the electronic circuit so as to be aligned with a target area on the electrical pad; said target area being sufficiently large to receive an antenna terminal from the radio-frequency identification device; and
contacting the antenna terminal with said at least one wall surface, while ensuring that a portion of said antenna terminal is at the height of the electrical pad.

24. A method as recited in claim 23, further comprising:
securing the terminal antenna to said wall assembly.

25. A method as recited in claim 23, wherein said providing on the electronic circuit a wall assembly is achieved by lithography.

26. A method as recited in claim 25, wherein said wall assembly includes two parallel rectangular-shaped bodies extending from the electronic circuit so as to define an inter-space D therebetween; each of said two parallel rectangular-shaped structures having a thickness h.

27. A method as recited in claim 26, wherein sharp edges are obtained on said two parallel rectangular-shaped structures by controlling the lithography process so as to yield a D/h ratio greater than a predetermined minimum design rule.

28. A method as recited in claim 26, wherein a V-shaped groove is obtained as said inter-space by controlling the lithography process so as to yield a D/h ratio lower than a predetermined minimum design rule.

29. A method as recited in claim 23, wherein said electronic circuit is a microchip; said providing on the electronic circuit a wall assembly is achieved by etching embedded layers of said microchip, so as to yield a rounded-edge rectangular body.

30. A method as recited in claim 23, wherein the terminal antenna is secured to said wall assembly by activating a mechanical attachment between the antenna terminal and said wall assembly.

31. A method as recited in claim 30, wherein connecting the terminal antenna to the electrical pad is performed simultaneously to activating a mechanical attachment between the antenna terminal and said wall assembly.

32. A method as recited in claim 30, activating a mechanical attachment between the antenna terminal and said wall assembly is achieved using process selected form the group consisting of thermo-compression, ultra-violet (UV) soldering, laser soldering, mono-components gluing, and bi-components gluing.

33. A method as recited in claim 23, wherein said wall assembly includes two opposite parallel walls extending from said electronic circuit surface defining a groove generally aligned with said pad; each of said two opposite parallel walls having a top surface parallel to said surfaces; contacting the antenna terminal with said at least one wall surface is achieved by swiping the antenna terminal onto said top surfaces of said two opposite parallel walls until the antenna terminal engages said groove.
